(19) United States
(12) Patent Application Publication
(10) Pub. No.: US 2026/0050086 A1
(43) Pub. Date: Feb. 19, 2026

(54) METHOD AND SYSTEM FOR REAL-TIME VEHICLE TRACKING-BASED DATA FORWARDING USING RECURSIVE LEAST SQUARES ESTIMATION IN VEHICULAR NAMED DATA NETWORKING ENVIRONMENT

(71) Applicant: Hoseo University Academic Cooperation Foundation, Asan-si (KR)

(72) Inventor: Huhn Kuk LIM, Daejeon (KR)

(21) Appl. No.: 19/060,988

(22) Filed: Feb. 24, 2025

(30) Foreign Application Priority Data
Aug. 14, 2024 (KR) 10-2024-0109449

(51) Int. Cl. G01S 19/06; G01S 19/27; G01S 19/37; G01S 19/39

(52) U.S. Cl. CPC G01S 19/06; G01S 19/27; G01S 19/37; G01S 19/393

(57) ABSTRACT

A real-time vehicle tracking-based data forwarding method and system for Vehicular Named Data Networking (VNDN) is provided. To address mobility-induced packet loss, Recursive Least Squares (RLS) estimation is used for accurate vehicle tracking. The system utilizes RSS, GPS, and speed information to predict vehicle location and trajectory, enabling proactive data forwarding to the anticipated location of the consumer vehicle. This approach reduces latency and enhances data delivery. A hop-by-hop feedback congestion control mechanism manages network congestion by adjusting packet transmission rates based on queue size information. Simulation results demonstrate significant improvements in Interest Satisfaction Rate, end-to-end delay, processed data packet copies, and packet loss ratio compared to conventional methods, particularly in high-mobility scenarios. This solution enhances reliable data transmission in dynamic vehicular networks.

### BACKGROUND OF THE INVENTION

### 1. Field of the Invention

The present invention relates to a method and system for real-time vehicle tracking-based data forwarding using Recursive Least Squares (RLS) estimation in a Vehicular Named Data Networking (VNDN) environment. More specifically, the invention relates to a method and system for dynamically estimating the location and trajectory of a consumer vehicle based on RLS estimation using various signal parameters, such as Received Signal Strength (RSS), GPS, and speed, and forwarding data packets to the predicted location of the consumer vehicle.

### 2. Description of the Related Art

Vehicular Named Data Networking (VNDN) is a novel architecture paradigm that combines Named Data Networking (NDN) with Vehicular Ad Hoc Networks (VANET). VNDN enables vehicles to request and receive named content within vehicular network environments. However, due to the high mobility of vehicles traveling on roads, there are frequent issues with network disconnections and packet loss. Therefore, a method is needed that can perform stable data transmission in any driving situation. References materials are as follows: 1) R. Hou et al., “Data forwarding scheme for vehicle tracking in named data networking,” IEEE Trans. Veh. Technol., vol. 70, no. 7, pp. 6684-6695, July 2021; 2) S. Zhou, M. Cui, R. Hou, and L. Zhao, “Data packet forwarding strategy based on vehicle tracking in named data networking,” in Proc. 2nd Int. Conf. Hot Inf.-Centric Netw. (HotICN), December 2019, pp. 66-71.

### SUMMARY OF THE INVENTION

This invention has been devised to solve the aforementioned problems, and aims to provide a data forwarding method and system that can accurately track the real-time location of a vehicle in VNDN, even during high-speed movement, to reduce packet loss and latency caused by mobility, enabling smooth and stable content search.

In order to solve such problems, there is provided a method for real-time vehicle tracking-based data forwarding, using a Recursive Least Squares (RLS) technique, performed by a RoadSide Unit (RSU) of a real-time vehicle tracking-based data forwarding system (hereinafter referred to as a “data forwarding system”) in a Vehicular Named Data Networking (VNDN) environment, the method comprising: (a) receiving an RSS value, GPS coordinates, and a speed value from a vehicle; (b) predicting a location and a trajectory of the vehicle by an RLS technique using the values received in step (a) and current Recursive Least Squares (RLS) parameters; (c) updating PIT entry information using a beacon message; (d) adjusting a packet transmission rate if necessary according to a packet waiting queue state of a next RSU; and (e) performing a packet forwarding process.

Step (b) may comprises: (b1) estimating a current location from a vector using the values received in step (a) and the current RLS parameters; (b2) calculating a Kalman gain vector from a previous estimate of a covariance matrix, an input signal vector, and a forgetting factor; (b3) updating an RLS parameter vector using the Kalman gain vector calculated in step (b2); (b4) updating the covariance matrix from the previous estimate of the covariance matrix, the Kalman gain vector, and the forgetting factor; and (b5) predicting the location of the vehicle from the updated RLS parameter vector.

Step (d) may comprises: (d1) receiving, from the next RSU, a notification of a status of the packet waiting queue through a beacon message when a size of the packet waiting queue of the next RSU exceeds or falls below a preset threshold; and (d2) adjusting the packet transmission rate to the next RSU according to the status of the packet waiting queue received in the notification. Preferably, the method further comprising: (f1) receiving a connection termination message from the vehicle for the vehicle to be connected to another RSU (hereinafter referred to as a “second RSU”) by handover when the vehicle receives an RSS larger than the RSS of the RSU from the second RSU; and (f2) terminating a connection with the vehicle.

Step (e) may comprises: (e11) receiving an Interest packet from the vehicle; and (e12) forwarding a Data packet of corresponding content to the vehicle when a content name of the Interest packet is found in a Content Store (CS).

Preferably, in step (e12), when the content name of the Interest packet is not found in the CS, it is checked whether the content is in a Pending Interest Table (PIT); when the content is in the PIT, a PIT entry is updated to “Interest InFace”; when the content is not in the PIT, a new PIT entry having an “Interest InFace” value is created, and then the Interest packet is forwarded to a next RSU using a Forwarding Information Base (FIB) table.

Step (e) may comprises: (e21) receiving a Data packet from the vehicle; (e22) checking a name of the Data packet in a Pending Interest Table (PIT); and (e23) forwarding the Data packet to a consumer vehicle when the name of the Data packet matches any one of PIT entries.

Step (e23) may comprises: (e231) checking whether the consumer vehicle is within a range of the RSU; and (e232) forwarding the Data packet to the consumer vehicle when the consumer vehicle is within the range of the RSU, and forwarding the Data packet to a next RSU based on a location of the consumer vehicle when the consumer vehicle is not within the range of the RSU.

With respect to other aspect of the present invention, there is provided a real-time vehicle tracking-based data forwarding system using an RLS technique in a Vehicular Named Data Networking (VNDN) environment, the system comprising: at least one processor; and at least one memory storing computer-executable instructions, wherein the computer-executable instructions stored in the at least one memory are executed by the at least one processor to perform: (a) receiving an RSS value, GPS coordinates, and a speed value from a vehicle; (b) predicting a location and a trajectory of the vehicle by a Recursive Least Squares (RLS) technique using the values received in step (a) and current RLS parameters; (c) updating PIT entry information using a beacon message; (d) adjusting a packet transmission rate if necessary according to a packet waiting queue state of a next RSU; and (e) performing a packet forwarding process.

According to the present invention, there is an effect of providing a data forwarding method and system that can accurately track the real-time location of a vehicle in VNDN, even during high-speed movement of the vehicle, to reduce packet loss and latency caused by mobility, enabling smooth and stable content search.

In particular, through the technique of dynamically estimating the location and trajectory of a consumer vehicle based on RLS estimation and forwarding data packets to the predicted location of the consumer vehicle, it shows superior results compared to conventional methods such as VTDF and Naive VNDN in terms of Interest Satisfaction Rate (ISR), end-to-end delay, Copies of Data Packets Processed (CDPP), and Packet Loss Ratio (PL ratio).

### BRIEF DESCRIPTION OF THE DRAWINGS

FIG. 1 illustrates data forwarding in a typical VNDN architecture.

FIG. 2A illustrates the transmission of an Interest packet from a consumer vehicle in a VNDN environment. It shows how the Interest packet propagates through the network until it reaches the producer vehicle.

FIG. 2B illustrates the corresponding transmission of a Data packet from a producer vehicle in response to the Interest packet shown in FIG. 2A. It depicts the reverse path of data delivery and highlights potential disruptions due to vehicle mobility.

FIG. 3 compares various mobility management methods in VNDN.

FIG. 4 illustrates the beacon message format used in the proposed system.

FIG. 5 presents the pseudocode of the RLS-based vehicle tracking algorithm with congestion control (CC).

FIG. 6 is a flowchart illustrating the location tracking and congestion control (CC) process in the proposed system.

FIG. 7 is a flowchart illustrating the location tracking-based data forwarding method.

FIG. 8A illustrates the initial stage of data forwarding using the RLS-based vehicle tracking technique in a VNDN environment. It shows how Interest packets and Data packets are transmitted between RSUs and vehicles.

FIG. 8B depicts the handover process when a consumer vehicle moves to a new RSU during ongoing data transmission, building upon the scenario in FIG. 8A.

FIG. 8C illustrates the application of the congestion control (CC) mechanism during data forwarding, which helps optimize packet delivery and reduce congestion as shown in FIG. 8A and FIG. 8B.

FIG. 9 explains the symbols used in the mathematical model of the RLS-based vehicle tracking technique.

FIG. 10 illustrates the simulation parameters used for evaluating the proposed RLS-based data forwarding technique.

FIG. 11A presents a comparative analysis of Interest Satisfaction Rate (ISR) based on the distance between consumer and producer vehicles.

FIG. 11B presents ISR variations based on network size, expanding upon the findings in FIG. 11A.

FIG. 11C presents ISR variations based on vehicle speed, showing how increased mobility impacts ISR.

FIG. 11D presents ISR variations based on the number of Interest packets, demonstrating how network congestion affects ISR in relation to FIG. 11A to FIG. 11C.

FIG. 12A evaluates the end-to-end delay in a VNDN environment concerning the distance between consumer and producer vehicles.

FIG. 12B evaluates the end-to-end delay concerning network size, showing how increased network density impacts delay, extending the observations from FIG. 12A.

FIG. 12C evaluates the end-to-end delay concerning vehicle speed, analyzing the effects of high-speed mobility on data transmission efficiency.

FIG. 12D evaluates the end-to-end delay concerning the number of Interest packets, illustrating how network congestion contributes to increased delay, in relation to FIG. 12A to FIG. 12C.

FIG. 13A compares the number of Copies of Data Packets Processed (CDPP) concerning the distance between consumer and producer vehicles.

FIG. 13B compares CDPP variations based on network size, complementing FIG. 13A.

FIG. 13C compares CDPP variations based on vehicle speed, showing how high mobility increases redundant data processing.

FIG. 13D compares CDPP variations based on the number of Interest packets, illustrating the relationship between increased network traffic and redundant packet processing in connection with FIG. 13A to FIG. 13C.

FIG. 14A compares the Packet Loss Ratio (PL ratio) concerning the distance between consumer and producer vehicles.

FIG. 14B compares the PL ratio variations based on network size, demonstrating how network congestion leads to increased packet loss, as seen in FIG. 14A.

FIG. 14C compares the PL ratio variations based on vehicle speed, analyzing how high mobility affects packet loss, building upon FIG. 14A and FIG. 14B.

FIG. 14D compares the PL ratio variations based on the number of Interest packets, showing how network congestion impacts packet delivery reliability, in relation to FIG. 14A to FIG. 14C.

FIG. 15 illustrates the configuration of an RSU in the real-time vehicle tracking-based data forwarding system using the RLS technique in a VNDN environment.

### DETAILED DESCRIPTION OF THE INVENTION

Hereinafter, a preferred embodiment of the present invention will be described in detail with reference to the accompanying drawings. It should be noted that the terms and words used in this specification and claims are not to be construed in their ordinary or dictionary sense, but rather in a sense and concept consistent with the technical idea of the invention, based on the principle that the inventor may properly define the concept of a term to best describe his invention. Therefore, the embodiments described in this specification and the configurations shown in the drawings are only preferred examples of the present invention and do not represent all the technical aspects of the invention. Thus, it should be understood that there may be various equivalents and modifications that can replace them at the time of this application.

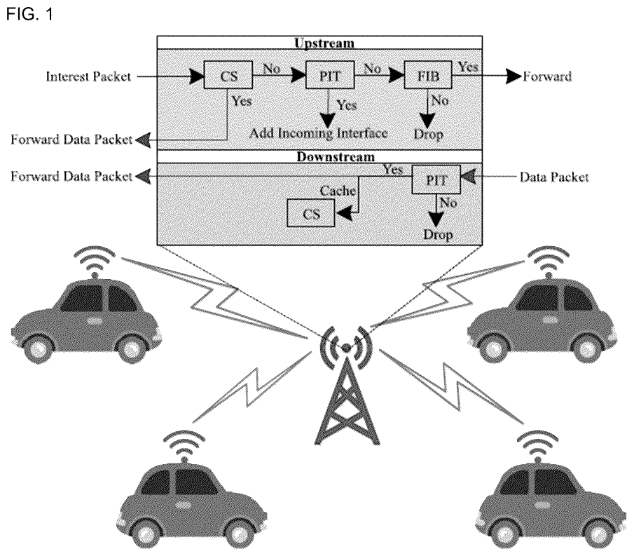

FIG. 1 is a diagram illustrating data forwarding in a typical VNDN architecture.

That is, FIG. 1 shows a general VNDN architecture and data forwarding procedure showing various components involved in data transmission and steps involved in the data forwarding process.

The VNDN (Vehicular Named Data Networking) architecture applies the content-centric networking model of NDN (Named Data Networking) to vehicular networks. The main components are as follows:
1. Content Store (CS): The CS is a local cache within a VNDN node that stores Data Packets based on names/prefixes. When an Interest Packet arrives, the CS checks for a matching prefix and returns the Data Packet to satisfy the request. This allows for faster responses to repeated requests from the onboard cache. However, due to resource constraints in vehicles, the storage capacity of the CS is limited, and cached data can be quickly replaced due to mobility.
2. Pending Interest Table (PIT): The PIT is responsible for keeping track of Interest Packets and the interface (InFace) they were received on. This information is used to route Data back to the vehicle that originally requested it. When Data arrives, the PIT uses the recorded entries to determine the downstream interface and forward the Data.
3. Forwarding Information Base (FIB): The FIB is responsible for forwarding Interest Packets based on name prefixes, serving as the forwarding table for name-based forwarding in VNDN. It is populated by various routing protocols and forwarding strategies. FIB lookups are used to select the interface to forward Interest Packets towards potential data sources.

In VNDN, vehicles and RoadSide Units (RSUs) exchange name-based Interest Packets and Data Packets, which are based on hierarchical content names instead of host IP addresses. This architecture decouples content retrieval from host location, enabling receiver-driven communication and addressing the unicast session and TCP overhead issues encountered in Vehicular Ad Hoc Networks (VANETs).

In a VNDN network, vehicles can act as consumers, producers, or intermediate nodes, while RSUs and core network nodes can act as intermediate forwarders with caching capabilities. This approach decouples data content from location, allowing data to be retrieved from anywhere, simplifying mobility in VNDN.

Data forwarding in VNDN is an essential component of the communication process. The primary goal of data forwarding in VNDN is to deliver data packets efficiently and reliably from the source to the destination. The data forwarding procedure in VNDN can be described as follows:
1) Interest Generation: A vehicle (consumer vehicle) that wishes to receive specific data content generates an Interest Packet containing the name of the requested data. The Interest Packet is then broadcast into the network. Interest Propagation: The Interest Packet is propagated from vehicle to vehicle, or from vehicle to RSU, until it reaches a node (producer vehicle) that holds the requested data content.
2) Data Packet Generation: The node (producer vehicle) generates a Data Packet, which includes the name and the content of the data.
3) Data Propagation: The Data Packet is propagated from node to node (reverse path) until it reaches the consumer vehicle.
4) Data Delivery: The consumer vehicle receives and processes the Data Packet. The Data Packet is then cached in the CS of the destination vehicle.

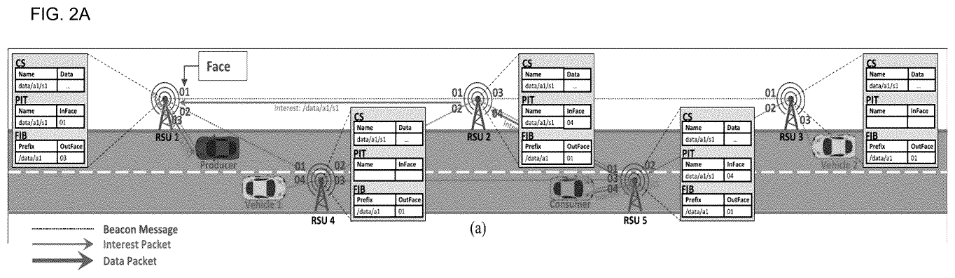

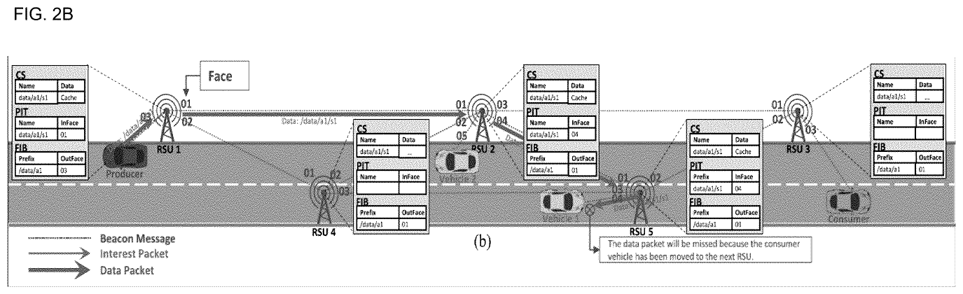

FIG. 2A is a diagram illustrating the transmission of an Interest packet from a consumer vehicle in a VNDN environment. It shows how the Interest packet propagates through the network until it reaches the producer vehicle. FIG. 2B is a diagram illustrating the corresponding transmission of a Data packet from a producer vehicle in response to the Interest packet shown in FIG. 2A. It depicts the reverse path of data delivery and highlights potential disruptions due to vehicle mobility.

Mobility management is a crucial aspect of ensuring efficient communication in VNDN. As both producer and consumer vehicles are highly mobile, disruptions in the reverse path can hinder data transmission. To mitigate this impact, it is essential to implement mobility management strategies that reduce traffic congestion and increase the speed of data packet delivery. Unlike TCP/IP, VNDN offers a better solution to mobility issues by allowing data access with names only.

Prefixes can be added for use regardless of the producer vehicle's IP address. Since vehicles communicate through On-board Units (OBUs), they can connect to the network via MAC (Media Access Control) addresses. This allows VNDN to support various connection modes like V2V, V2R, V2I, V2P, and V2E, facilitating the immediate connection of mobile vehicles.

The VNDN mobility management method improves communication speed and reduces network management overhead by decreasing the number of IP address changes required for mobile devices. VNDN enhances data retrieval by decoupling the location of the content, allowing data to be obtained from any nearby vehicle or RSU, regardless of the original producer. Additionally, this architecture simplifies mobility management, providing a system capable of efficiently handling vehicle mobility in vehicular networks.

FIG. 2A and FIG. 2B illustrate the conventional data forwarding process in a VNDN environment. FIG. 2A assumes that at time T(1), a consumer vehicle generates an Interest packet for specific content with the content name (Interest: /data/a1/s1) and transmits it to RSU5.

RSU5 checks its CS for the requested content. If not found, RSU5 checks its PIT for an entry that satisfies the Interest packet. If there is no matching entry, RSU5 records the name entry and the receiving face of the Interest packet in its PIT. Then, RSU5 checks its FIB to determine the next hop for the Interest packet based on the content name prefix. RSU5 forwards the Interest packet to RSU2 through OutFace 01.

RSU2 repeats the same process and forwards the Interest packet to RSU1. Upon receiving the Interest packet, RSU1 directly forwards it to the producer vehicle with the requested content as/data/a1/s1. At time T2, considering FIG. 2B, the producer vehicle responds with a Data packet (Data/data/a1/s1) and transmits it back to RSU1. RSU1 checks its PIT to find a matching entry for the Data packet and forwards it to RSU2, the receiving side of the Interest packet. RSU2 also checks its PIT and forwards the Data packet to RSU5. In the current scenario, when RSU5 receives the Data packet and attempts to deliver it to the consumer vehicle, it fails because the consumer vehicle has moved to the next RSU, RSU3.

In reverse path 2 at time T, the Data packet follows the same route as the Interest packet. However, if the consumer vehicle changes its location during the data forwarding process, the Data packet may not reach its destination. Data forwarding in VNDN involves multiple hops and depends on the location of the vehicles and the availability of forwarders. Therefore, accurate prediction of the consumer vehicle's location through efficient route estimation is essential for reliable data transmission in VNDN environments.

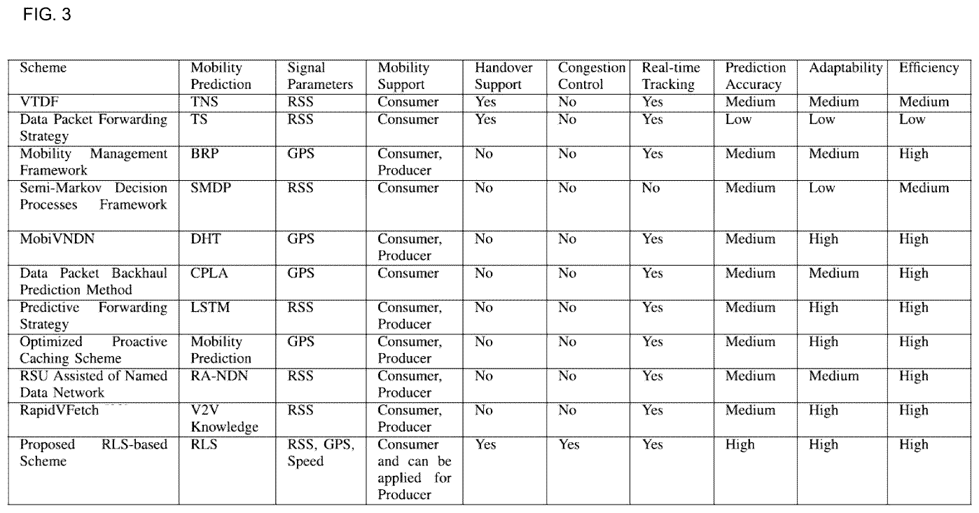

FIG. 3 is a diagram comparing various mobility management techniques in VNDN.

In particular, the RLS-based method of the present invention, shown at the bottom of FIG. 3, uniquely incorporates multiple signal parameters (RSS, GPS, speed) for real-time tracking. This method employs hop-by-hop congestion control (hereinafter referred to as “CC”) during Interest packet/Data packet forwarding to support mobility and handover, as well as network congestion. These features offer advantages over other approaches and are potentially more effective in VNDN environments. Moreover, the proposed RLS-based method offers higher prediction accuracy, adaptability, and efficiency than existing related studies used in VNDN environments. The primary objective of this invention is to explore the potential of vehicle tracking-based mobility management techniques to effectively reduce data transmission delays and losses in VNDN. While currently designed around consumer vehicle mobility, this technique can be adapted to producer vehicle mobility with slight modifications. Considering the limitations of existing research efforts, we propose a novel data forwarding scheme based on real-time route estimation using the RLS algorithm.

Among various legacy approaches, this invention focuses on vehicle tracking-based mobility management and VNDN handover. The RLS-based data forwarding technique of the present invention enables the selection of appropriate RSUs for data packet forwarding by tracking the location of vehicles in motion.

This invention provides a more reliable and efficient communication mechanism in VNDN environments by enhancing data forwarding and reducing packet loss, exhibiting better performance compared to the VTDF method and native VNDN. The proposed method can potentially improve the performance of VNDN and be applied to various use cases, such as emergency services and infotainment applications.

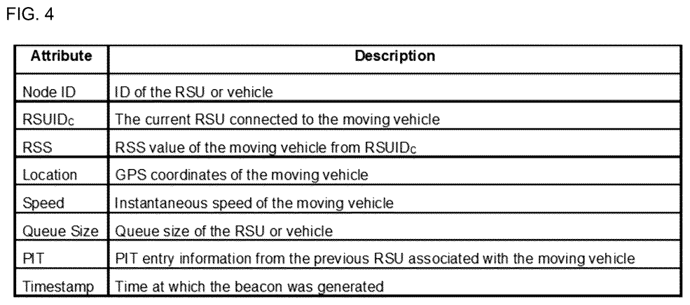

FIG. 4 is a diagram illustrating a beacon message format.

Hereinafter, a novel real-time vehicle tracking method using RLS estimation is described to address the mobility management issues in VNDN. The key idea is to leverage multiple signal parameters to estimate vehicle locations and predict movement patterns in real-time.

In the RLS-based method of the present invention, all RSUs/vehicles periodically exchange beacon messages using the WAVE (Wireless Access in Vehicular Environments) communication channel to share crucial information. These beacon messages include attributes such as node ID, RSS, location (GPS coordinates), speed, RSU ID, queue size, PIT information, and timestamp, as illustrated in FIG. 4. Through beacon message exchanges, nodes can monitor the network status and adjust their operations accordingly.

The RSS, GPS coordinates, and speed information can be used for vehicle tracking in the RLS-based technique of the present invention. The RSU ID attribute indicates the current RSU to which the vehicle is connected. The queue size attribute can be used for the CC mechanism. The PIT attribute indicates that the PIT entry information of the previous RSU connected to the moving vehicle can be shared with the relevant RSU.

The proposed technique utilizes an RLS-based estimation method to obtain output information that can be used to track the movement of vehicles using real-time inputs like RSS, GPS coordinates, and speed. The proposed technique can be used to monitor and track the location of vehicles in VNDN. RSS can be used to estimate the distance between the RSU and the vehicle. On the other hand, GPS coordinates and speed are used to estimate the current location of the vehicle and predict its subsequent locations. The output of RLS includes information such as the current location and speed of the vehicle, as well as the predicted path of the vehicle based on its current direction and speed.

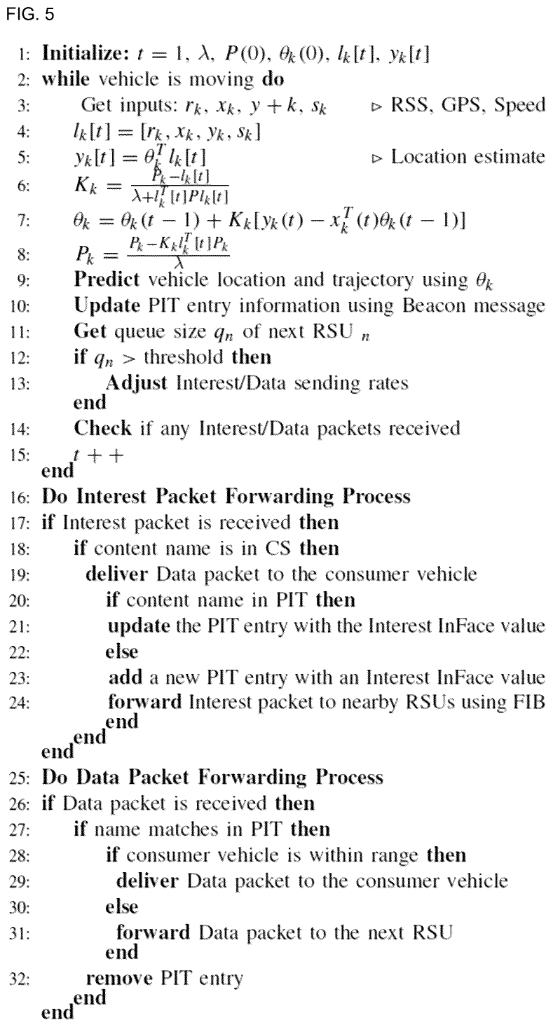

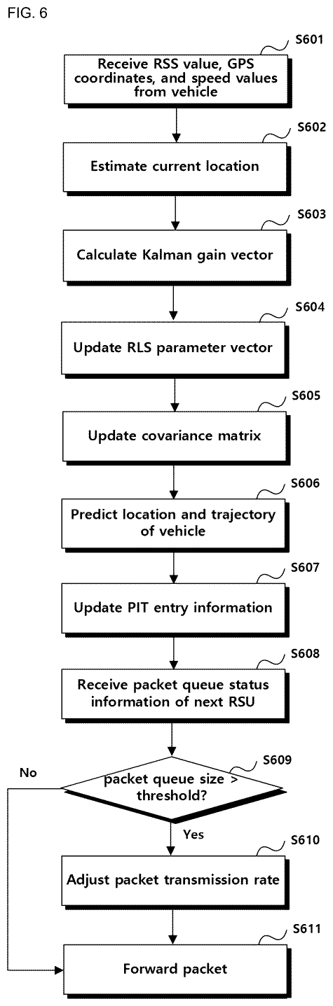

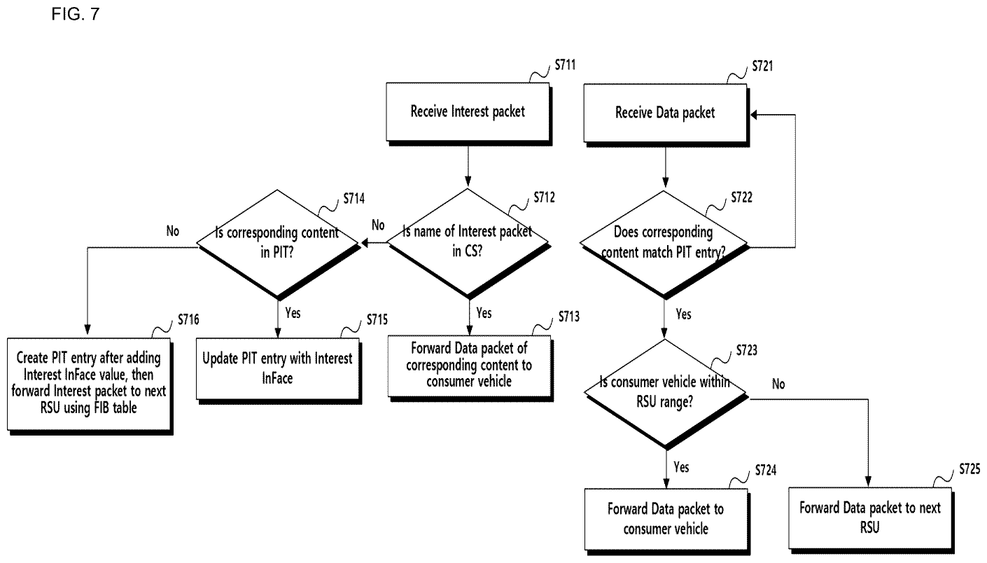

FIG. 5 is a diagram showing the RLS-based vehicle tracking algorithm using CC of the present invention in pseudocode, FIG. 6 is a flowchart illustrating the location tracking and CC method in the location tracking-based data forwarding of the present invention, and FIG. 7 is a flowchart illustrating the location tracking-based data forwarding method of the present invention.

The algorithm begins by initializing RLS parameters, including time (t), forgetting factor (λ), covariance matrix (P(0)), parameter vector (θk (0)), input vector (lk[t]), and output (yk[t]). The algorithm then enters a loop that continues as long as the vehicle is moving.

In each iteration of the loop, the algorithm first takes the RSS rk, GPS coordinates xk, yk, and speed sk as inputs (S601, see FIG. 6). These inputs are stored in the input vector lk[t]. The algorithm then estimates the location of the vehicle using the current parameter vector and the input vector (S602). The RLS parameter vector and covariance matrix are updated using RLS update equations (S604, S605). The algorithm then predicts the location and trajectory of the vehicle using the updated parameter vector (S606). The customized RLS mathematical model for vehicle tracking is presented in Section IV. This algorithm can also be used to update PIT entries based on the location of the vehicle from the beacon messages. If an Interest packet/Data packet is received, the algorithm applies a hop-by-hop feedback CC mechanism and gets the queue size of the next RSU (S608). If the queue size exceeds a certain threshold (S609), the algorithm adjusts the transmission rate of the Interest packet/Data packet (S610). The algorithm then checks if an Interest packet/Data packet is received and increments the time variable.

When an Interest packet is received (S711, see FIG. 7), the algorithm proceeds to the next step and initiates the Interest packet forwarding process. If the content name is found in the CS (S712), the algorithm directly forwards the corresponding Data packet to the consumer vehicle (S713). If the content name is not found in the CS (S712), the algorithm checks if the content is present in the PIT (S714). If the content name is found in the PIT, the algorithm updates the PIT entry with the Interest InFace value (S715). If the content name is not found in the PIT, the algorithm creates a new entry in the PIT with the Interest InFace value and forwards the Interest packet to the next RSU using the FIB table (S716).

When a Data packet is received (S721), the algorithm proceeds to the next step and starts the Data packet forwarding process. The algorithm checks the name of the received Data packet in the PIT. If the name matches any of the PIT entries (S722), the algorithm verifies if the consumer vehicle is within range (S723). If the consumer vehicle is within the range of the current RSU, the algorithm forwards the Data packet to that vehicle (S724). If the consumer vehicle is not within the range of the current RSU, the algorithm forwards the Data packet to the next RSU based on its location (S725). According to the RLS-based method of the present invention, all RSUs continuously track the location of moving vehicles and update PIT entries by exchanging beacon messages. After delivering or forwarding the Data packet, the algorithm removes the corresponding entry from the PIT. If the name of the Data packet does not match any PIT entry, the algorithm discards the packet.

The OBU of a moving vehicle continuously monitors the Signal-to-Interference-plus-Noise Ratio (SINR) of the signals received from multiple RSUs through physical layer communication. However, the vehicle can only establish a connection with the RSU that provides the strongest RSS based on the SINR. To calculate the RSS value, the following equation can be used:

$$SINR = \frac{S}{I + N} \qquad ( 1 )$$

where S represents the power of the desired signal from the RSU ID. I represents the average interference signal received from other RSUs, and N represents the background noise.

Therefore, the RSS value can be calculated from the SINR value using the following equation:

$$RSS = S + I + N \qquad ( 2 )$$

where S represents the received signal power, and I and N represent the interference and noise values, respectively.

The RSS values are randomly collected from multiple RSUs, each with its ID. The RSU with the strongest RSS is identified and used as the RSU ID in the beacon message.

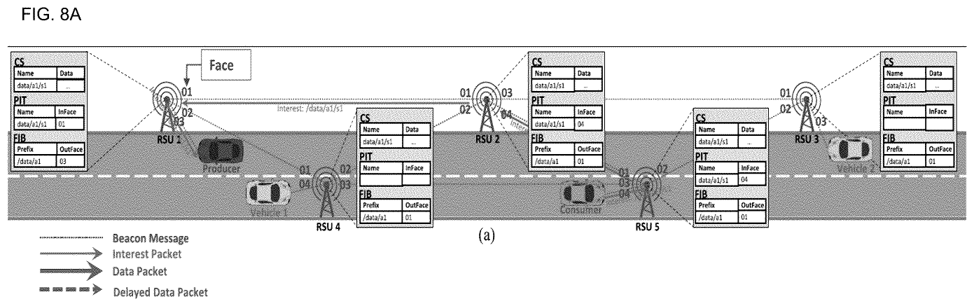

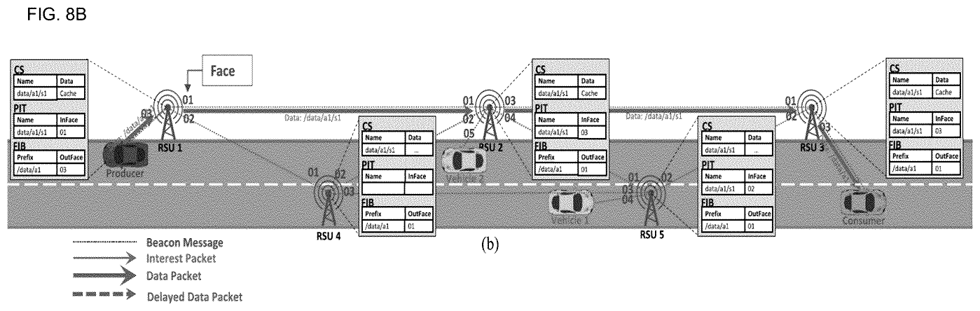

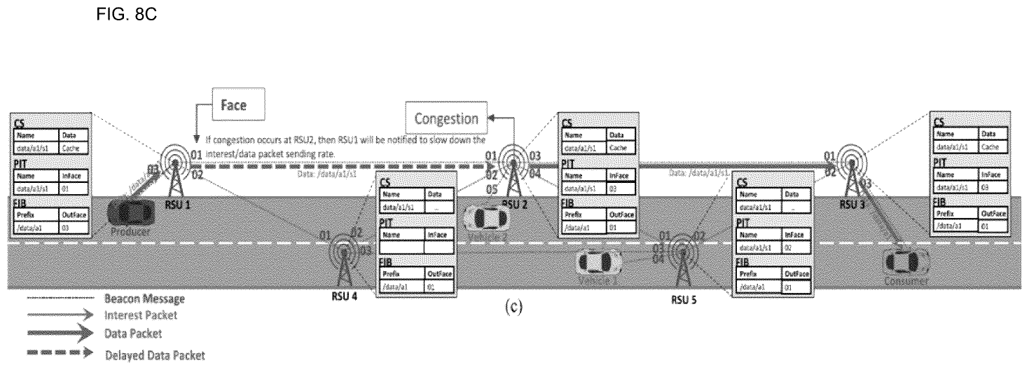

FIG. 8A to 8C are diagrams illustrating a data forwarding model using the RLS-based vehicle tracking technique with CC.

In our proposed RLS-based method, when a consumer vehicle requires specific content, it generates an Interest packet containing the name and propagates it through the network. The nearest RSU receives the Interest packet along with the RSS, GPS coordinates, and speed values of the consumer vehicle. All RSUs utilize the proposed RLS-based scheme to estimate the current and future locations of the consumer vehicle and update the PIT entries accordingly. During the Interest packet/Data packet forwarding process, all RSUs employ a hop-by-hop feedback CC mechanism, continuously monitoring network congestion and swiftly adjusting packet transmission rates to accommodate the flow. When the consumer vehicle moves out of the coverage area of the current RSU, the RSU forwards the Data packet to the next predicted RSU based on the vehicle's estimated location. This is achieved by sharing PIT entry information through beacon messages to ensure reliable delivery of the requested Data packet.

FIG. 8A to 8C illustrate the proposed data forwarding model using the RLS-based scheme for vehicle tracking with CC support. This model incorporates RLS estimation for accurate vehicle tracking and a CC mechanism to ensure adaptive data forwarding. A mesh topology is considered where all RSUs exchange beacon messages and update PIT entries among themselves, between RSUs and vehicles, and between vehicles and RSUs. In FIG. 8A, it is assumed that at time T(1), the consumer vehicle transmits an Interest packet, requesting specific data content with the name/data/a1/s1. This Interest packet traverses through RSU5, RSU2, and RSU1 to reach the producer vehicle. FIG. 8B shows that at time T(2), the consumer vehicle changes its location and moves to RSU3. While moving, the consumer vehicle receives multiple RSS values from various surrounding RSUs, such as RSU5 and RSU3. When the RSS value of RSU3 becomes stronger than that of RSU5 [RSU3 RSS>RSU5 RSS], the handover process is initiated, and the consumer vehicle disconnects from RSU5 and connects to RSU3. The handover process in VNDN is crucial to maintain seamless connectivity as vehicles move from one RSU to another. During the handover process, the consumer vehicle transmits beacon messages to RSU5 and RSU3, changing the connected RSU ID from RSU5 C to RSU3C. Once the handover process is completed, RSU5 shares the PIT entry information of the Interest/data/a1/s1 with RSU3 and RSU2, which are connected to the consumer vehicle, using beacon messages. According to the proposed data forwarding model, RSU5, RSU2, and RSU3 update their PIT entries to accept and forward the Data packet/data/a1/s1. For instance, RSU2 changes the PIT InFace value from 4 to 3. Now, when the Data packet (Data/data/a1/s1) is received at RSU2, it forwards it to RSU3. Consequently, RSU3 receives the Data packet and delivers it to the consumer vehicle. In case of congestion, a CC mechanism is employed at the RSUs, as described below.

In VNDN, network congestion can significantly impact data transmission efficiency, affecting QoS performance when the dynamic network topology changes due to vehicle mobility. In this invention, a hop-by-hop feedback CC mechanism is employed.

The hop-by-hop feedback CC mechanism operates as follows:
1) RSUs exchange beacon messages with each other using the WAVE communication channel. Each RSU continuously monitors its own queue size to track the amount of Interest packets/Data packets waiting to be transmitted.
2) If the queue size exceeds or falls below a specified threshold {qn>threshold}, the RSU sends an explicit notification to all connected RSUs through beacon messages. This notification serves as a signal to the RSUs that congestion is occurring.
3) Upon receiving the congestion message, all connected RSUs adjust their Interest packet/Data packet transmission rates. The adjustment is made according to the available rate specified in the received notification.

Referring to FIG. 8C, it is assumed that congestion occurs at RSU2 while forwarding the Data packet. RSU2 sends an explicit notification about the congestion to RSU1 through a beacon message, based on the queue threshold. Accordingly, RSU1 adjusts its data transmission rate to accommodate the congested RSU2 link. After employing the hop-by-hop feedback CC, RSU2 forwards the Data packet to the final RSU, RSU3. RSU3 then delivers the Data packet to the consumer vehicle.

Unlike TCP's conventional end-to-end CC approach, which reacts to congestion after data packets are lost, the hop-by-hop feedback CC mechanism prevents data packet loss proactively by regulating the flow rate of Interest packets/Data packets. This enables rapid adaptation to changes in available bandwidth. Consequently, packet loss is reduced, ensuring reliable data delivery, especially for real-time vehicle tracking.

The utilization of the hop-by-hop feedback CC mechanism enhances the robustness and stability of the VNDN environment.

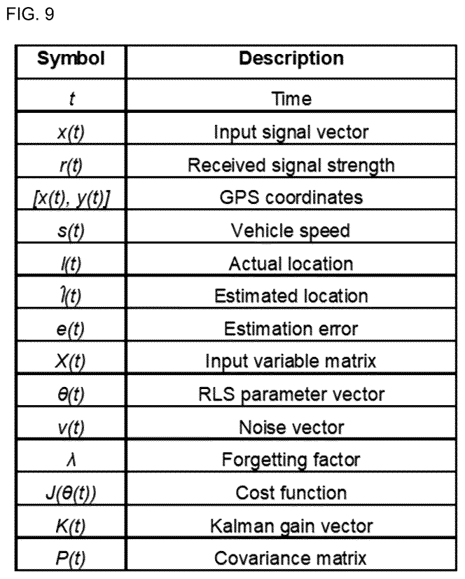

FIG. 9 is a diagram explaining the symbols used in the mathematical model of the RLS-based vehicle tracking technique of the present invention.

This section describes the mathematical model for tracking vehicles in real-time using the RLS technique. The core concept involves leveraging received signal parameters, such as RSS, GPS, and speed, to dynamically estimate vehicle locations through an adaptive RLS filter.

Building upon the vehicle tracking scheme described earlier, a customized mathematical model for real-time tracking of consumer vehicles using the RLS estimation technique is now presented. By incorporating multiple signal input parameters, such as RSS, GPS coordinates, and speed, this invention proposes an RLS-based vehicle tracking scheme specifically tailored for VNDN environments. The proposed RLS-based estimation model recursively receives these input parameters and predicts future values to track the location of vehicles. By recursively updating the estimates, RLS can adapt to changes in the system and track the location of the vehicle with high accuracy. In this manner, each RSU can continuously estimate the consumer vehicle location in real-time and proactively forward data packets based on the predicted movement patterns. This approach of accurately tracking vehicle mobility in real-time using multi-parameter RLS estimation aims to significantly improve reliability and reduce latency in highly dynamic VNDN environments.

The key mathematical notations and concepts used to formulate the RLS-based tracking model are presented in FIG. 9, which summarizes the meaning and role of each symbol and concept used within the equations.

As mentioned earlier, the core idea is for the RSU to track the consumer vehicle location based on received signal parameters such as RSS, GPS coordinates, and speed. Consider a VNDN environment with consumer vehicles ci, producer vehicles pj, and RSUs. The goal is to track the location lk(t) of the consumer vehicle ck at time t based on the input signal parameters:
Received Signal Strength (RSS): rk
GPS coordinates: (xk, yk)
Speed: sk

At time t, the RSU receives a vector containing the input signal parameters for vehicle ck:

$${x}_{k} ( t ) = {[ {r}_{k} ( t ) , {x}_{k} ( t ) , {y}_{k} ( t ) , {s}_{k} ( t ) ]}^{T} \qquad ( 3 )$$

where rk(t) is the RSS, (xk(t), yk(t)) are the GPS coordinates, and sk(t) is the speed of vehicle ck at time t. The RSU processes these inputs using an RLS estimator to produce a location estimate as follows:

$${\hat{l}}_{k} ( t ) = f [ RLS \{ {x}_{k} ( t ) ; θ ( t ) \} ] \qquad ( 4 )$$

where the vector θ(t) represents the parameters of the RLS estimator, which are updated recursively. f denotes the RLS estimation function that takes the input signal vector xk(t) and the parameter vector θ(t) to produce the location estimate \hat{l}ₖ(t).

The estimation error ek(t) is defined as the square of the Euclidean distance between the actual location lk(t) and the estimated location \hat{l}x(t). The objective is to minimize the estimation error:

$${e}_{k} ( t ) = {\vert {l}_{k} ( t ) - {\hat{l}}_{k} ( t ) \vert}^{2} \qquad ( 5 )$$

Through Eq. (5), each RSU can track surrounding vehicles in real-time based on multi-parameter inputs, as envisioned in the proposed method.

There are two main stages in the RLS-based estimation technique:
1. Linear Regression: The location lk(t) of the vehicle ck at time t is modeled as a linear function of the input signal parameters.

$${l}_{k} ( t ) = {X}_{k} ( t ) {θ}_{k} ( t ) + {e}_{k} ( t ) \qquad ( 6 )$$

where X represents the regressor variables of x, θ represents the parameter vector, and e represents the error. This allows for the representation of the location as a weighted combination of the input signal parameters.
2. Recursive Least Squares: The parameter vector θ(t) is estimated recursively by minimizing a weighted least squares cost function.

$${J}_{k} [ θ ( t ) ] = {\sum }_{i = 1}^{t} {{λ}^{t - i} [ {y}_{k} ( i ) - {x}_{k}^{T} ( i ) θ ( t ) ]}^{2} \qquad ( 7 )$$

where λ is the forgetting factor used in RLS estimation. The forgetting factor is a constant between 0 and 1 that weights the input samples in the cost function J(θ(t)) for calculating the parameter vector θ(t). The purpose of λ is to apply exponential weighting to the input samples, giving more weight to recent samples compared to older ones. This allows the RLS estimator to adapt more quickly to changes or dynamics in the system.

Using recursive update equations, the Kalman gain vector K(t) can be calculated as follows:

$${K}_{k} ( t ) = \frac{P ( t - 1 ) {x}_{k} ( t )}{λ + {x}_{k}^{T} ( t ) P ( t - 1 ) {x}_{k} ( t )} \qquad ( 8 )$$

where P(t−1) is the previous estimate of the covariance matrix, xk(t) is the input signal vector, and λ is the forgetting factor. Intuitively, K(t) determines how much the new input data xk(t) updates the parameter estimate and is calculated using the previous covariance P(t−1) and the new input xk(t).

$${θ}_{k} ( t ) = {θ}_{k} ( t - 1 ) + {K}_{k} ( t ) [ {y}_{k} ( t ) - {x}_{k}^{T} ( t ) {θ}_{k} ( t - 1 ) ] \qquad ( 9 )$$

This takes the previous parameter vector θ(t−1) and adds the innovation term (in parentheses) scaled by K(t). This innovation term is the difference between the actual output yk(t) and the predicted output using the previous parameters

$${x}_{k}^{T} ( t ) {θ}_{k} ( t - 1 ) .$$

Finally, the covariance matrix P(t) is updated as follows:

$${P}_{k} ( t ) = \frac{P ( t - 1 ) - {K}_{k} ( t ) {x}_{k}^{T} ( t ) P ( t - 1 )}{λ} \qquad ( 10 )$$

This takes the previous P(t−1) and reduces it by scaling with the forgetting factor λ along with the new Kalman gain and input vector.

By applying this recursion, the RLS estimator can adaptively track the vehicle location based on the latest input signal parameters.

In this subsection, we analyze the complexity of the proposed RLS-based algorithm for vehicle tracking in terms of time complexity, comparing the proposed method with conventional methods.

The time complexity of the proposed method is mainly determined by the RLS algorithm and the data forwarding algorithm. The RLS algorithm involves matrix operations such as multiplication, inversion, and subtraction, and since the matrix size is fixed and small, its time complexity is constant at O(1). The data forwarding algorithm involves distance calculations and comparisons, which have a linear time complexity of O(n), where n is the number of neighboring vehicles.

Since the RLS algorithm is executed for each vehicle at each RSU, the time complexity is O(m), where m is the number of vehicles in the network. The data forwarding algorithm is executed for each data packet at each vehicle, so the time complexity is O(kn), where k is the number of data packets in the network.

Therefore, the total time complexity of the proposed scheme is O(m+kn). This represents an improvement in computational complexity compared to conventional methods, which have a time complexity of O(n\hat{ }2). This improvement makes the proposed method more efficient and scalable for real-time vehicle tracking and data forwarding in VNDN.

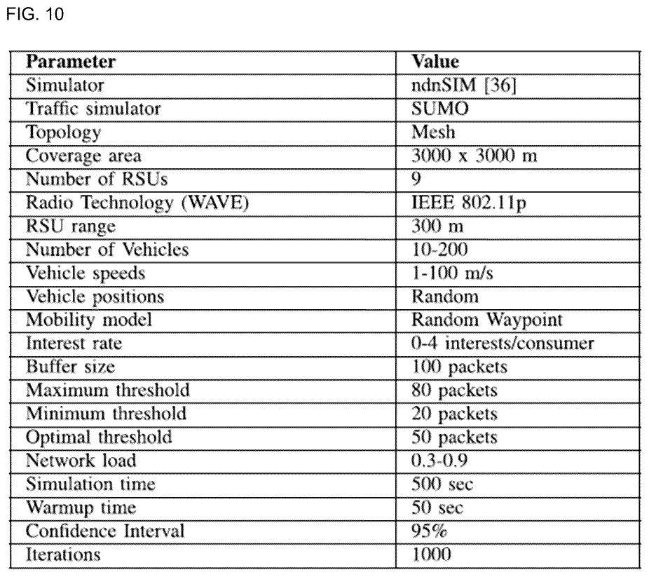

FIG. 10 is a diagram illustrating the simulation parameters of the location tracking-based data forwarding technique using RLS in VNDN of the present invention.

Extensive simulations were conducted to evaluate the performance of the proposed VNDN scheme and compare it with existing schemes. A VNDN scenario spanning a 3000×3000 meter bi-directional highway was created. Simulation of Urban Mobility (SUMO) is used to generate realistic vehicle movement patterns in this area. Nine RSUs equipped with IEEE 802.11p wireless technology (WAVE) with a transmission range of 300m are randomly placed to create a mesh topology. All RSUs exchange beacon messages with surrounding connected vehicles and other RSUs, sharing useful information. Vehicle density varies from 10 to 200 vehicles, comprising consumer vehicles (25%), intermediate vehicles (50%), and content producer vehicles (25%). Vehicles move according to the Random Waypoint mobility model, with speeds ranging from 1 m/s to 100 m/s as designated in SUMO, representing a dynamic urban scenario. In every iteration, each consumer vehicle generates 0 to 4 Interest packets and propagates them in the network to retrieve Data packets for the required content. In-network caching capability is enabled at all RSUs to store temporary copies of returned Data packets in the local RSU cache. A buffer size of 100 packets is used for CC, with maximum, minimum, and optimal thresholds set to 80, 20, and 50 packets, respectively. The network load ranges from 0.3 to 0.9. The simulation time is 500 seconds, including a warm-up period of 50 seconds. Monte Carlo simulations are run with varying random seeds over 1000 iterations to ensure statistical confidence in the results within a 95% confidence interval.

In the following sections, we evaluate the performance of the proposed RLS-based scheme with and without CC and compare it with the existing VTDF techniques from prior arts 1 and 2 and Naive VNDN in terms of Interest Satisfaction Rate (ISR), end-to-end delay, Copies of Data Packets Processed (CDPP), and Packet Loss Ratio (PL ratio).

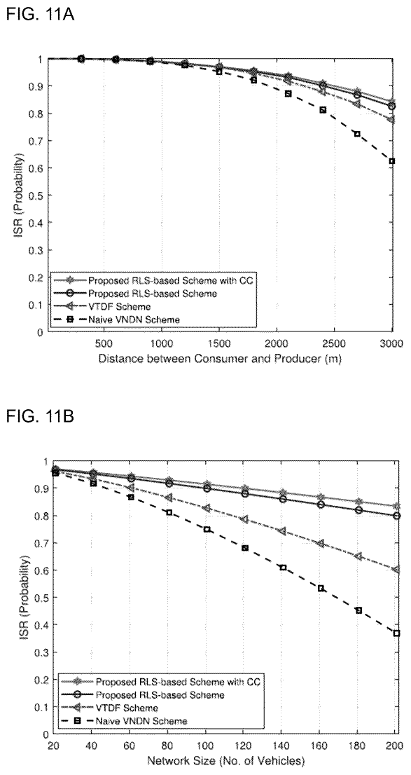

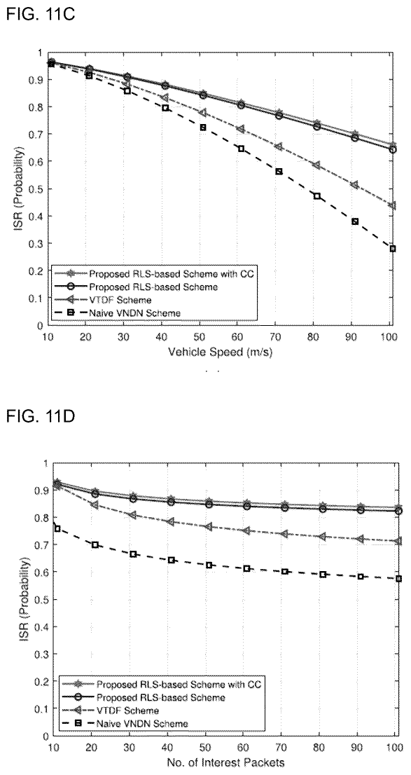

FIGS. 11A to 11D are diagrams showing the results of a comparative analysis of ISR in a VNDN environment, considering various parameters such as distance between consumer and producer vehicles, network size, vehicle speed, and number of Interest packets.

ISR is defined as the ratio of the number of successful Data packet deliveries to the total number of Interest packets generated, and is used as a key performance indicator in VNDN.

FIG. 11A examines the relationship between ISR and the distance between consumer and producer vehicles. The results show that distance negatively impacts ISR in all schemes. This is because longer distances require more hops to deliver Data packets, resulting in a higher chance of packet loss. However, the proposed RLS-based scheme performs better than the VTDF and Naive VNDN schemes due to optimal forwarding and reliable data delivery to the target RSU. Employing hop-by-hop feedback CC can further enhance ISR by reducing packet loss during network congestion.

FIG. 11B investigates the impact of network size (number of vehicles) on ISR. It is observed that as the number of vehicles increases, ISR decreases in all schemes. In densely populated vehicular network environments, the increased traffic load and ping-pong effect increase the likelihood of packet loss. The proposed RLS-based scheme maintains a higher ISR compared to the VTDF and Naive VNDN schemes due to accurate data forwarding to the target RSU. Consequently, the Data packet delivery rate increases. Additionally, hop-by-hop feedback CC further reduces packet loss due to improved congestion management.

FIG. 11C illustrates the relationship of ISR to vehicle speed. As vehicle speed increases, ISR decreases in all schemes due to unstable connections during high mobility. This leads to a failure in delivering Data packets to consumer vehicles. However, the proposed RLS-based scheme achieves a higher ISR than the VTDF and Naive VNDN schemes at all speeds. This is because it is best suited for mobility management and optimal data delivery due to more accurate vehicle tracking and data forwarding to the target RSU in high-mobility environments. Employing hop-by-hop feedback CC further improves ISR and reduces packet loss due to better network management.

FIG. 11D shows the relationship between ISR and the number of Interest packets was analyzed. As Interest packets increase, ISR decreases in all schemes because increased network congestion leads to higher Data packet loss. However, the proposed RLS-based scheme can achieve a high ISR by forwarding data to the predicted RSU, ensuring successful transmission of Data packets. Furthermore, hop-by-hop feedback CC further enhances ISR by effectively managing network congestion and ensuring reliable transmission of Data packets. Without CC, some packets may be lost during network congestion.

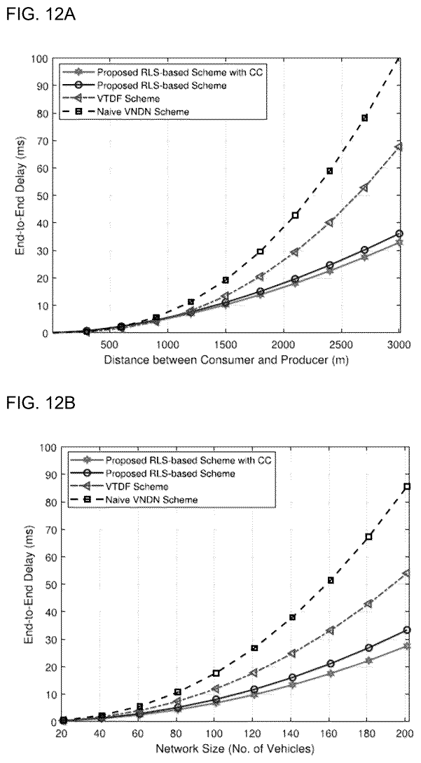

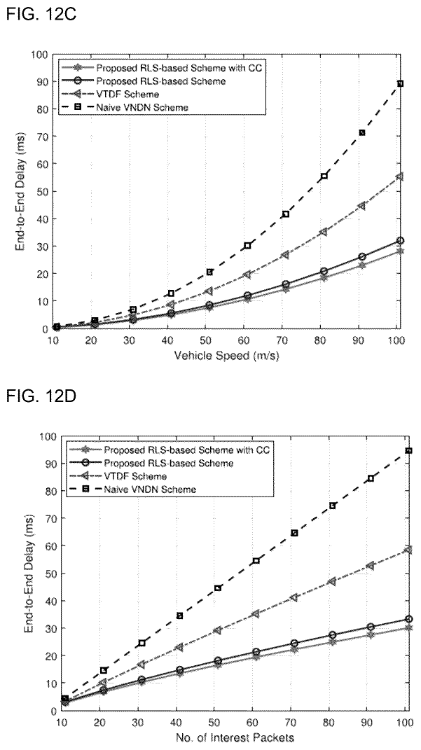

FIGS. 12A to 12D are diagrams evaluating end-to-end delay in various parameters of a VNDN environment.

End-to-end delay is defined as the total time it takes for a Data packet to travel from the producer vehicle to the consumer vehicle. The main contributors to high end-to-end delay in VNDN are increased distance between vehicles, high vehicle mobility, and network congestion.

FIG. 12A shows the end-to-end delay of various schemes in a VNDN environment. As distance increases, all schemes experience increased end-to-end delay as more hops and additional time are required to transmit Data packets from the producer vehicle to the consumer vehicle. However, the proposed RLS-based scheme exhibits lower delay compared to the VTDF and Naive VNDN schemes. The proposed RLS-based scheme can deliver faster to the consumer vehicle by reducing hops through tracking the location of the consumer vehicle. Furthermore, hop-by-hop feedback CC can further reduce end-to-end delay by improving network congestion by reducing queuing delay.

FIG. 12B examines the end-to-end delay in a VNDN environment as the network size scales. When more vehicles generate more data traffic, it can lead to higher network congestion, resulting in increased end-to-end delay. However, the RLS scheme can maintain lower end-to-end delay compared to the VTDF and Naive VNDN schemes. The biggest reason is that the RLS-based scheme provides adaptive data forwarding by tracking vehicle locations. And Data packets can be transmitted through the shortest possible path. The hop-by-hop feedback CC can further reduce end-to-end delay by reducing queuing delay during network congestion.

FIG. 12C shows the impact of vehicle speed on end-to-end delay in a VNDN environment. With higher speeds, vehicles change RSUs and routes frequently, leading to disconnections and failed Data packet transmissions, thereby increasing end-to-end delay. Nevertheless, the experimental results show that the proposed RLS-based scheme minimizes end-to-end delay under high mobility conditions, which is also true when compared with the VTDF and Naive VNDN schemes. This is because the proposed RLS-based scheme provides better mobility management by tracking vehicles more accurately in real-time and delivering Data packets more optimally. Incorporating hop-by-hop feedback CC can further reduce end-to-end delay by minimizing queuing delays. Without CC support, packets may be queued in the outgoing queue if network congestion occurs.

FIG. 12D shows the end-to-end delay as the number of Interest packets increases. When there are more Interest packets, the network becomes congested, leading to end-to-end delay due to buffer overflow and queuing delays. The proposed RLS-based scheme has a lower end-to-end delay than the VTDF and Naive VNDN schemes even when more Interest packets are generated. The proposed scheme tracks consumer vehicle locations to select optimal paths, ensuring fast and reliable transmission. The hop-by-hop feedback CC helps reduce network delay by reducing the time Data packets spend in the queue during congestion. Consequently, packets can be transmitted faster while minimizing delays. However, without CC support, delays can occur due to outgoing queues, potentially increasing end-to-end delay.

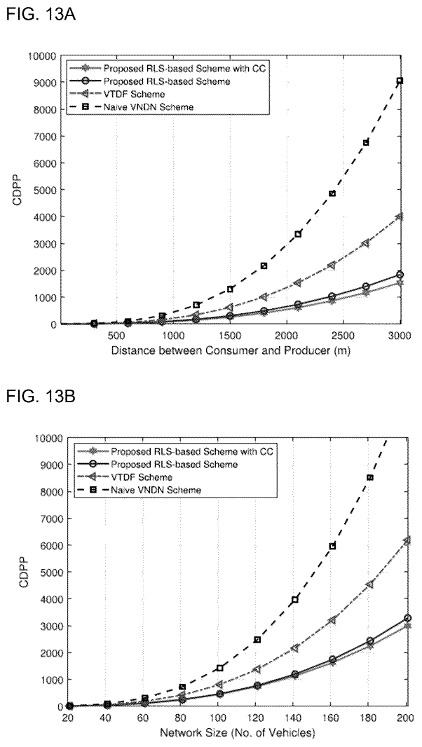

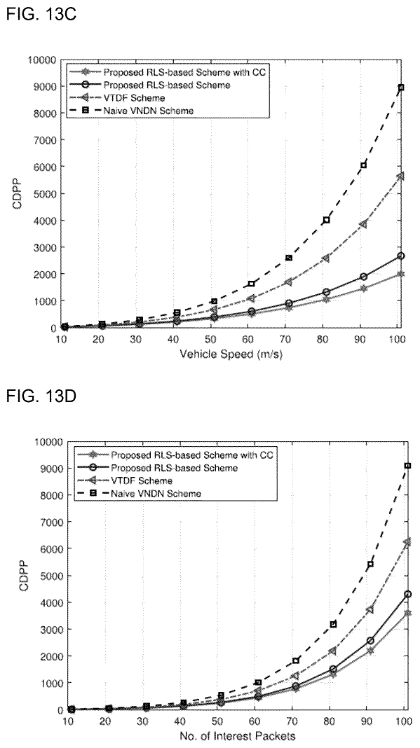

FIGS. 13A to 13D are diagrams comparing the CDPP of various techniques according to various parameters in a VNDN environment.

CDPP refers to the number of copies of Data packets generated and processed within the VNDN.

FIG. 13A compares CDPP with the distance between consumer and producer vehicles. As the distance between vehicles increases, CDPP also increases. This is because more hops and routes are required to successfully deliver data to the consumer vehicle. Consequently, the proposed RLS-based scheme has a lower CDPP compared to the VTDF and Naive VNDN schemes. The proposed RLS-based scheme uses a lower number of hops and tracks the location to deliver data reliably to the consumer vehicle. As a result, there are fewer Interest copies for the same Data packet. Employing hop-by-hop feedback CC can further reduce CDPP as it minimizes redundant copies of Interest packets and Data packets during network congestion.

In FIG. 13B, the impact of network size on CDPP was analyzed. As the network size scales, CDPP increases in all schemes, as a higher number of vehicles generate more data traffic and utilize more resources, leading to redundant copies of Data packets within the network. The RLS-based scheme exhibits consistently lower CDPP compared to the VTDF and Naive VNDN schemes, even with an increasing number of vehicles. This can be achieved by optimally forwarding Data packets and traversing fewer hops. The RLS-based scheme selects the target RSU based on vehicle tracking, even with a large number of vehicles. Incorporating hop-by-hop feedback CC further reduces CDPP due to reliable Data packet transmission. Without CC support, Data packets may be lost, and redundant Interests may occur for the same Data packet.

In FIG. 13C, we examine CDPP in relation to vehicle speed. As vehicle speed increases, CDPP also increases, as higher vehicle mobility results in more frequent changes in network topology. Consequently, redundant copies of Data packets are generated and processed within the VNDN environment. The proposed RLS-based scheme generates and processes fewer redundant copies of Data packets compared to the VTDF and Naive VNDN schemes. Due to more accurate vehicle tracking and adaptive data forwarding, the proposed scheme uses a lower number of hops to deliver data to the consumer vehicle under high mobility conditions. Moreover, hop-by-hop feedback CC contributes to further reducing CDPP by minimizing packet loss during network congestion.

FIG. 13D focuses on the impact of the number of Interest packets on CDPP. As the number of Interest packets transmitted through the network increases, CDPP also increases for all schemes. This is because more Interests require more Data packets to be generated and processed within the VNDN environment. The proposed RLS-based scheme exhibits better performance in terms of CDPP than the VTDF and Naive VNDN schemes, even with an increasing number of Interest packets. The proposed scheme achieves this by selecting optimal paths that utilize a lower number of RSUs to forward Data packets. Fewer RSUs result in reduced CDPP. Additionally, hop-by-hop feedback CC helps reduce CDPP by minimizing packet loss and providing reliable data transmission.

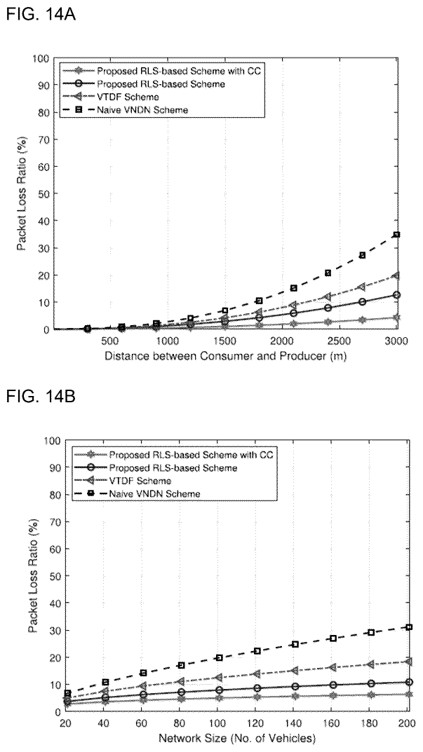

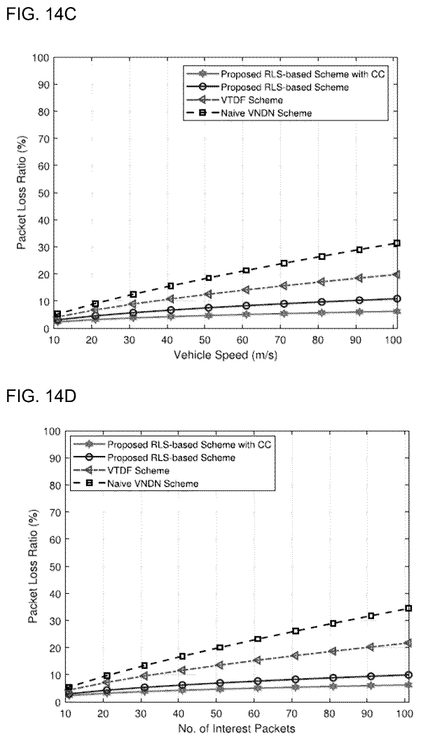

FIGS. 14A to 14D are diagrams comparing the Packet Loss Ratio (PL ratio) achieved by various methods in a VNDN environment.

The PL ratio measures the proportion of packets that fail to reach their intended destination in VNDN, which can occur due to network congestion (buffer overflow) and disruptions caused by vehicle movement.

FIG. 14A compares the PL ratio when increasing the distance between consumer and producer vehicles. As the distance increases, more forwarding hops are required, leading to a higher chance of route disruptions and packet loss. Consequently, the proposed RLS-based method is shown to reduce the PL ratio compared to the VTDF and Naive VNDN methods. The proposed RLS-based method selects reliable and optimal paths for successfully delivering Data packets to consumer vehicles by tracking locations in real-time. Hop-by-hop feedback CC is employed to reduce packet loss in case network congestion occurs. This helps reduce the PL ratio compared to schemes without CC support.

FIG. 14B analyzes the PL ratio with respect to network size in a VNDN environment. As the network size scales, the PL ratio also increases. The main reason is that more vehicles generate more data traffic, leading to congestion (buffer overflow) and packet loss. The proposed RLS-based scheme provides a better PL ratio compared to the VTDF and Naive VNDN schemes. This is attributed to its reliable delivery of Data packets to moving vehicles. This scheme forwards Data packets to the target RSU in dense networks by tracking the location of the consumer vehicle. By employing hop-by-hop feedback CC, proactive measures are taken to prevent buffer overflow and reduce packet loss, further lowering the PL ratio.

In FIG. 14C, we analyze the PL ratio in relation to vehicle speed in a VNDN environment. The PL ratio exhibits an increasing trend with increasing vehicle speed in all schemes due to frequent changes in network topology and disruptions in data delivery. The proposed RLS-based method outperforms the VTDF and Naive VNDN methods in terms of PL ratio, providing better mobility management and optimal data forwarding even during high-speed vehicle movement. The RLS-based method, with the support of hop-by-hop feedback CC, effectively manages network congestion and prevents buffer overflow, further reducing packet loss even during high-speed vehicle movement.

FIG. 14D shows the PL ratio with an increasing number of Interest packets in a VNDN environment. As the number of Interest packets increases, the PL ratio increases as follows due to network congestion and buffer overflow.

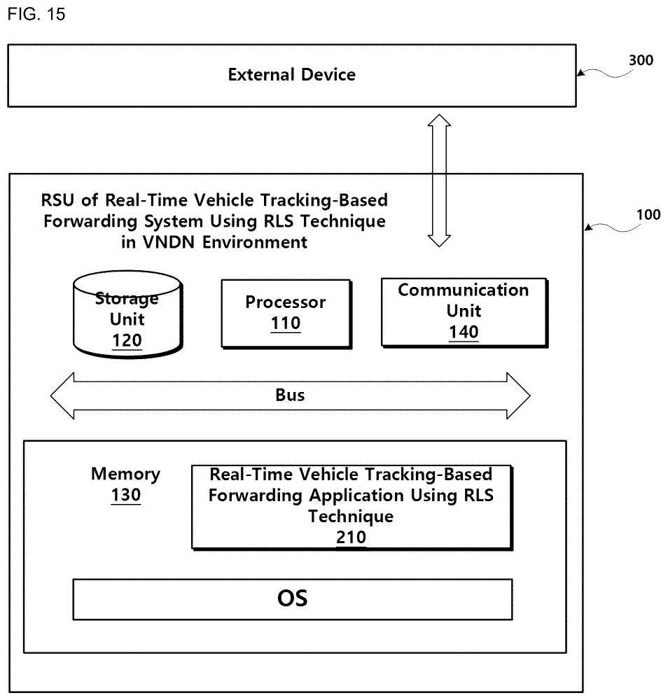

FIG. 15 is a diagram illustrating a configuration of an RSU of the real-time vehicle tracking-based data forwarding system (100) using the RLS technique in a VNDN environment.

The RSU of the real-time vehicle tracking-based data forwarding system (100) using the RLS technique in a VNDN environment includes a processor (110), a non-volatile storage (120) for storing programs and data, a volatile memory (130) for storing programs being executed, a communication unit (140) for performing communication with external devices (300), and a bus as an internal communication path between these devices. The programs being executed may include device drivers, an operating system (OS), and various applications. Although not shown, the RSU of the real-time vehicle tracking-based data forwarding system (100) using the RLS technique may also include a power providing unit such as a battery.

The real-time vehicle tracking-based data forwarding application using the RLS technique (hereinafter referred to as “data forwarding application” 210) is a program installed and operated on the real-time vehicle tracking-based data forwarding system (100) using the RLS technique in a VNDN environment.

As described above, although the present invention has been described by means of limited embodiments and drawings, the invention is not limited thereby, and various modifications and variations can be made by those having ordinary knowledge in the technical field to which the invention belongs, within the technical idea of the invention and the equitable scope of the claims of the patent, which will be described below.

What is claimed is:

1. A method for real-time vehicle tracking-based data forwarding, using a Recursive Least Squares (RLS) technique, performed by a RoadSide Unit (RSU) of a real-time vehicle tracking-based data forwarding system (hereinafter referred to as a “data forwarding system”) in a Vehicular Named Data Networking (VNDN) environment, the method comprising:
(a) receiving an RSS value, GPS coordinates, and a speed value from a vehicle;
(b) predicting a location and a trajectory of the vehicle by an RLS technique using the values received in step (a) and current Recursive Least Squares (RLS) parameters;
(c) updating PIT entry information using a beacon message;
(d) adjusting a packet transmission rate if necessary according to a packet waiting queue state of a next RSU; and
(e) performing a packet forwarding process.

2. The method of claim 1, wherein step (b) comprises:
(b1) estimating a current location from a vector using the values received in step (a) and the current RLS parameters;
(b2) calculating a Kalman gain vector from a previous estimate of a covariance matrix, an input signal vector, and a forgetting factor;
(b3) updating an RLS parameter vector using the Kalman gain vector calculated in step (b2);
(b4) updating the covariance matrix from the previous estimate of the covariance matrix, the Kalman gain vector, and the forgetting factor; and
(b5) predicting the location of the vehicle from the updated RLS parameter vector.

3. The method of claim 1, wherein step (d) comprises:
(d1) receiving, from the next RSU, a notification of a status of the packet waiting queue through a beacon message when a size of the packet waiting queue of the next RSU exceeds or falls below a preset threshold; and
(d2) adjusting the packet transmission rate to the next RSU according to the status of the packet waiting queue received in the notification.

4. The method of claim 1, further comprising:
(f1) receiving a connection termination message from the vehicle for the vehicle to be connected to another RSU (hereinafter referred to as a “second RSU”) by handover when the vehicle receives an RSS larger than the RSS of the RSU from the second RSU; and
(f2) terminating a connection with the vehicle.

5. The method of claim 1, wherein step (e) comprises:
(e11) receiving an Interest packet from the vehicle; and
(e12) forwarding a Data packet of corresponding content to the vehicle when a content name of the Interest packet is found in a Content Store (CS).

6. The method of claim 5, wherein in step (e12), when the content name of the Interest packet is not found in the CS, it is checked whether the content is in a Pending Interest Table (PIT); when the content is in the PIT, a PIT entry is updated to “Interest InFace”; when the content is not in the PIT, a new PIT entry having an “Interest InFace” value is created, and then the Interest packet is forwarded to a next RSU using a Forwarding Information Base (FIB) table.

7. The method of claim 1, wherein step (e) comprises:
(e21) receiving a Data packet from the vehicle;
(e22) checking a name of the Data packet in a Pending Interest Table (PIT); and
(e23) forwarding the Data packet to a consumer vehicle when the name of the Data packet matches any one of PIT entries.

8. The method of claim 7, wherein step (e23) comprises:
(e231) checking whether the consumer vehicle is within a range of the RSU; and
(e232) forwarding the Data packet to the consumer vehicle when the consumer vehicle is within the range of the RSU, and forwarding the Data packet to a next RSU based on a location of the consumer vehicle when the consumer vehicle is not within the range of the RSU.

9. A real-time vehicle tracking-based data forwarding system using an RLS technique in a Vehicular Named Data Networking (VNDN) environment, the system comprising:
at least one processor; and
at least one memory storing computer-executable instructions,
wherein the computer-executable instructions stored in the at least one memory are executed by the at least one processor to perform:
(a) receiving an RSS value, GPS coordinates, and a speed value from a vehicle;
(b) predicting a location and a trajectory of the vehicle by a Recursive Least Squares (RLS) technique using the values received in step (a) and current RLS parameters;
(c) updating PIT entry information using a beacon message;
(d) adjusting a packet transmission rate if necessary according to a packet waiting queue state of a next RSU; and
(e) performing a packet forwarding process.
